(19) United States
(12) Patent Application Publication
(10) Pub. No.: US 2017/0286980 A1
(43) Pub. Date: Oct. 5, 2017

(54) EVALUATING IMPACT OF IN-STORE DISPLAYS ON SHOPPING BEHAVIOR

(71) Applicant: Information Resources, Inc., Chicago, IL (US)

(72) Inventors: Eric Wayne Winters, Cornelius, NC (US); William J. Ilaria, Cranford, NJ (US)

(21) Appl. No.: 15/083,817

(22) Filed: Mar. 29, 2016

(51) Int. Cl. G06Q 30/02

(52) U.S. Cl. CPC G06Q 30/0205; G06Q 30/0201

(57) ABSTRACT

Data from disparate sources including panel data, display audit data, point of sale data, trade area data, and store data are combined and analyzed to derive a model that relates in-store display attributes to individual shopping behavior. In particular, techniques are proposed for linking information about in-store displays with shopping data for individual consumers in order to create a model characterizing whether purchasing behavior for a particular shopper, trip type, and/or the basket contents are influenced by a particular in-store display. These inferences can further be projected onto a larger population or trade area to predict impact of different promotional strategies using in-store displays.

### TECHNICAL FIELD

This application relates to techniques for evaluating the impact of in-store displays on individual shopper behavior.

### BACKGROUND

An enduring goal of marketing analytics is to evaluate the impact of marketing campaigns and advertising on consumer behavior. While a variety of aggregate statistics are available for evaluating the overall effectiveness of displays in promoting sales, it can be particularly difficult to identify the effect of in-store displays on particular shoppers or shopper types. Existing techniques attempt to address this information gap by tracking specific consumers as they move through a venue and interact with various displays, but this can impose significant infrastructure costs on the venue, produce unreliable results, and/or produce results inapplicable to real-world scenarios. There remains a need for improved techniques for evaluating the impact of in-store displays on individual shopper.

### SUMMARY

Data from disparate sources including panel data, display audit data, point of sale data, trade area data, and store data are combined and analyzed to derive a model that relates in-store display attributes to individual shopping behavior. In particular, techniques are proposed for linking information about in-store displays with shopping data for individual consumers in order to create a model characterizing whether purchasing behavior for a particular shopper, trip type, and/or the basket contents are influenced by a particular in-store display. These inferences can further be projected onto a larger population or trade area to predict impact of different promotional strategies using in-store displays.

### BRIEF DESCRIPTION OF THE FIGURES

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 shows a market analytics network environment.

FIG. 2 illustrates a computing system.

FIG. 3 illustrates a data environment for a modeling process.

FIG. 4 shows a method for evaluating impact of in-store displays.

FIG. 5 illustrates a method for developing a consumer response model.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “third,” “above,” “below,” and the like, are words of convenience and are not to be construed as limiting terms unless expressly state otherwise.

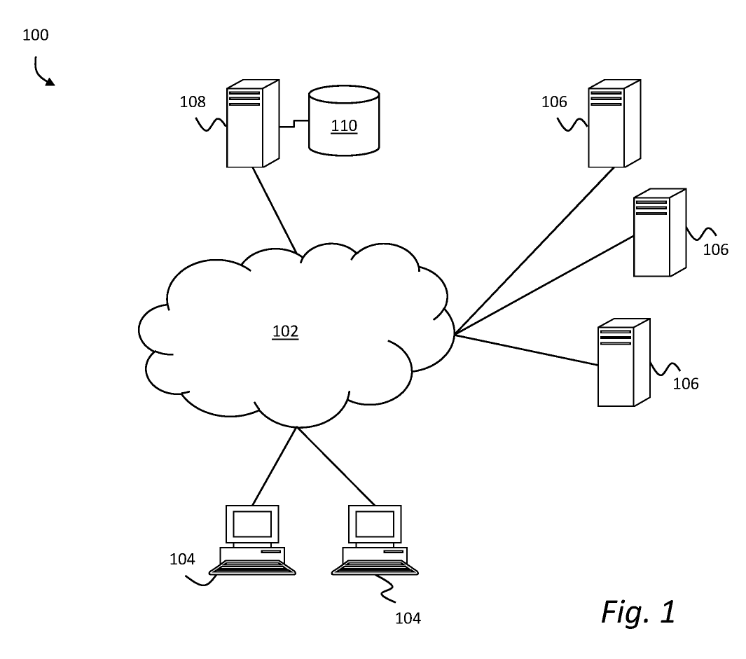

FIG. 1 shows a market analytics network environment. The system 100 may include a data network 102 such as the Internet that interconnects any number of clients 104, data sources 106, and servers 108 (each of which may include a database 110). In general, the server 108 may secure data from the various data sources 106 and provide a user interface to clients 104 for creating and using models based on data from the data sources 106.

The data network 102 may include any network or combination of networks suitable for interconnecting other entities as contemplated herein. This may, for example, include the Public Switched Telephone Network, global data networks such as the Internet and World Wide Web, cellular networks that support data communications (such as 3G, 4G and LTE networks), local area networks, corporate or metropolitan area networks, wide area wireless networks and so forth, as well as any combination of the foregoing and any other networks suitable for data communications between the clients 104, data sources 106 and the server 108.

The clients 104 may include any device operable by end users to interact with the servers 108 and data sources 106 through the data network 102. This may, for example, include a desktop computer, a laptop computer, a tablet, a cellular phone, a smart phone, and any other device or combination of devices similarly offering a processor and communications interface collectively operable as a client device within the data network 102. In general, a client 104 may interact with the server 108 and locally render a user interface such as a web page or the like for a user to access services hosted by the server 108. This may include a variety of data analytics and data management tools, as well as administrative tools for creating accounts, controlling access to data, and so forth. The servers 108 may also support interaction by an end user with the data sources 106 or related services provided by the server 108.

The data sources 106 may include any sources of data for tracking or analyzing consumer purchasing behavior, such as any of the various sources of data described herein, or any other useful sources of information. Examples of data that may be included in the data sources 106 include without limitation panel data, display audit data, point of sale data, trade area data, store data, and the like. It will be appreciated that in general such data may be stored in the data sources 106 remote from one of the servers 108, or stored in a database 110 local to one of the servers 108, or some combination of these, all of which are generally referred to herein as a database. In general, the physical and logical arrangement of such a database may be in any form, and one of the servers 108 may provide a seamless interface to such data in any suitable format. A variety of potential data sources are discussed in greater detail below.

The server 108 may include any number of physical or logical machines according a desired level of service, scalability, processing power or any other design parameters. In general, the server 108 may be configured to gather data from data sources 106 and process the data to create models such as those contemplated herein. In addition, the server 108 may provide a programming interface for creating and modifying models, a user interface for using the models, and an administrative interface for managing models, data, data access, user accounts, and so forth, as well as any other tools or interfaces suitable for creating or interacting with models as contemplated herein. In one aspect, the server 108 may include a number of separate functional components (which may be similarly logically or physically separated, or embodied in a single machine) such as one server coupled to the data sources 106 for managing communications therewith, such as through an application or database programming interface, a second server that provides a user interface to clients 104, and a third server that provides statistical engines and the like for creating and using models based on the data.

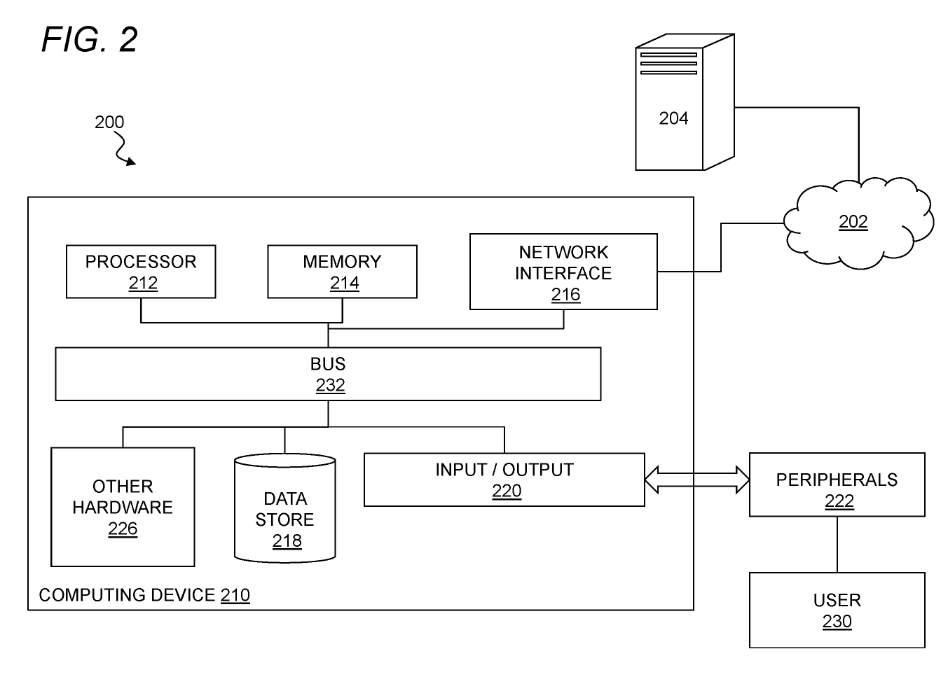

FIG. 2 illustrates a computer system. In general, the computer system 200 may include a computing device 210 connected to a network 202, e.g., through an external device 204. The computing device 210 may be or include any of the network entities described above including data sources, servers, client devices, and so forth. For example, the computing device 210 may include a desktop computer workstation. The computing device 210 may also or instead be any device suitable for interacting with other devices over a network 202, such as a laptop computer, a desktop computer, a personal digital assistant, a tablet, a mobile phone, a television, a set top box, a wearable computer, and the like. The computing device 210 may also or instead include a server such as any of the servers described above. In certain aspects, the computing device 210 may be implemented using hardware or a combination of software and hardware. The computing device 210 may be a standalone device, a device integrated into another entity or device, a platform distributed across multiple entities, or a virtualized device executing in a virtualization environment.

The network 202 may include any network described above, e.g., data network(s) or internetwork(s) suitable for communicating data and control information among participants in the computer system 200. This may include public networks such as the Internet, private networks, and telecommunications networks such as the Public Switched Telephone Network or cellular networks using third generation cellular technology (e.g., 3G or IMT-2000), fourth generation cellular technology (e.g., 4G, LTE. MT-Advanced, E-UTRA, etc.) or WiMax-Advanced (IEEE 802.16m)) and/or other technologies, as well as any of a variety of corporate area, metropolitan area, campus or other local area networks or enterprise networks, along with any switches, routers, hubs, gateways, and the like that might be used to carry data among participants in the computer system 200. The network 202 may also include a combination of data networks, and need not be limited to a strictly public or private network.

The external device 204 may be any computer or other remote resource that connects to the computing device 210 through the network 202. This may include any of the servers or data sources described above.

In general, the computing device 210 may include a processor 212, a memory 214, a network interface 216, a data store 218, and one or more input/output interfaces 220. The computing device 210 may further include or be in communication with peripherals 222 and other external input/output devices that might connect to the input/output interfaces 220.

The processor 212 may be any processor or other processing circuitry capable of processing instructions for execution within the computing device 210 or computer system 200. The processor 212 may include a single-threaded processor, a multi-threaded processor, a multi-core processor and so forth. The processor 212 may be capable of processing instructions stored in the memory 214 or the data store 218.

The memory 214 may store information within the computing device 210. The memory 214 may include any volatile or non-volatile memory or other computer-readable medium, including without limitation a Random Access Memory (RAM), a flash memory, a Read Only Memory (ROM), a Programmable Read-only Memory (PROM), an Erasable PROM (EPROM), registers, and so forth. The memory 214 may store program instructions, program data, executables, and other software and data useful for controlling operation of the computing device 210 and configuring the computing device 210 to perform functions for a user. The memory 214 may include a number of different stages and types of memory for different aspects of operation of the computing device 210. For example, a processor may include on-board memory and/or cache for faster access to certain data or instructions, and a separate, main memory or the like may be included to expand memory capacity as desired. All such memory types may be a part of the memory 214 as contemplated herein.

The memory 214 may, in general, include a non-volatile computer readable medium containing computer code that, when executed by the computing device 210 creates an execution environment for a computer program in question, e.g., code that constitutes processor firmware, a protocol stack, a database management system, an operating system, or a combination of the foregoing, and that performs some or all of the steps set forth in the various flow charts and other algorithmic descriptions set forth herein. While a single memory 214 is depicted, it will be understood that any number of memories may be usefully incorporated into the computing device 210. For example, a first memory may provide non-volatile storage such as a disk drive for permanent or long-term storage of files and code even when the computing device 210 is powered down. A second memory such as a random access memory may provide volatile (but higher speed) memory for storing instructions and data for executing processes. A third memory may be used to improve performance by providing higher speed memory physically adjacent to the processor 212 for registers, caching and so forth.

The network interface 216 may include any hardware and/or software for connecting the computing device 210 in a communicating relationship with other resources through the network 202. This may include remote resources accessible through the Internet, as well as local resources available using short range communications protocols using, e.g., physical connections (e.g., Ethernet), radio frequency communications (e.g., WiFi), optical communications, (e.g., fiber optics, infrared, or the like), ultrasonic communications, or any combination of these or other media that might be used to carry data between the computing device 210 and other devices. The network interface 216 may, for example, include a router, a modem, a network card, an infrared transceiver, a radio frequency (RF) transceiver, a near field communications interface, a radio-frequency identification (RFID) tag reader, or any other data reading or writing resource or the like.

More generally, the network interface 216 may include any combination of hardware and software suitable for coupling the components of the computing device 210 to other computing or communications resources. By way of example and not limitation, this may include electronics for a wired or wireless Ethernet connection operating according to the IEEE 802.11 standard (or any variation thereof), or any other short or long range wireless networking components or the like. This may include hardware for short range data communications such as Bluetooth or an infrared transceiver, which may be used to couple to other local devices, or to connect to a local area network or the like that is in turn coupled to a data network 202 such as the Internet. This may also or instead include hardware/software for a WiMax connection or a cellular network connection (using, e.g., CDMA, GSM, LTE, or any other suitable protocol or combination of protocols). The network interface 216 may be included as part of the input/output devices 220 or vice-versa.

The data store 218 may be any internal memory store providing a computer-readable medium such as a disk drive, an optical drive, a magnetic drive, a flash drive, or other device capable of providing mass storage for the computing device 210. The data store 218 may store computer readable instructions, data structures, program modules, and other data for the computing device 210 or computer system 200 in a non-volatile form for relatively long-term, persistent storage and subsequent retrieval and use. For example, the data store 218 may store an operating system, application programs, program data, databases, files, and other program modules or other software objects and the like.

The input/output interface 220 may support input from and output to other devices that might couple to the computing device 210. This may, for example, include serial ports (e.g., RS-232 ports), universal serial bus (USB) ports, optical ports, Ethernet ports, telephone ports, audio jacks, component audio/video inputs, HDMI ports, and so forth, any of which might be used to form wired connections to other local devices. This may also or instead include an infrared interface, RF interface, magnetic card reader, or other input/output system for wirelessly coupling in a communicating relationship with other local devices. It will be understood that, while the network interface 216 for network communications is described separately from the input/output interface 220 for local device communications, these two interfaces may be the same, or may share functionality, such as where a USB port is used to attach to a WiFi accessory, or where an Ethernet connection is used to couple to a local network attached storage.

A peripheral 222 may include any device used to provide information to or receive information from the computing device 200. This may include human input/output (I/O) devices such as a keyboard, a mouse, a mouse pad, a track ball, a joystick, a microphone, a foot pedal, a camera, a touch screen, a scanner, or other device that might be employed by the user 230 to provide input to the computing device 210. This may also or instead include a display, a speaker, a printer, a projector, a headset or any other audiovisual device for presenting information to a user. The peripheral 222 may also or instead include a digital signal processing device, an actuator, or other device to support control of or communication with other devices or components. Other I/O devices suitable for use as a peripheral 222 include haptic devices, three-dimensional rendering systems, augmented-reality displays, and so forth. In one aspect, the peripheral 222 may serve as the network interface 216, such as with a USB device configured to provide communications via short range (e.g., BlueTooth, WiFi, Infrared, RF, or the like) or long range (e.g., cellular data or WiMax) communications protocols. In another aspect, the peripheral 222 may augment operation of the computing device 210 with additional functions or features, such as a global positioning system (GPS) device, a security dongle, or any other device. In another aspect, the peripheral 222 may include a storage device such as a flash card, USB drive, or other solid state device, or an optical drive, a magnetic drive, a disk drive, or other device or combination of devices suitable for bulk storage. More generally, any device or combination of devices suitable for use with the computing device 200 may be used as a peripheral 222 as contemplated herein.

Other hardware 226 may be incorporated into the computing device 200 such as a co-processor, a digital signal processing system, a math co-processor, a graphics engine, a video driver, a camera, a microphone, speakers, and so forth. The other hardware 226 may also or instead include expanded input/output ports, extra memory, additional drives (e.g., a DVD drive or other accessory), and so forth.

A bus 232 or combination of busses may serve as an electromechanical backbone for interconnecting components of the computing device 200 such as the processor 212, memory 214, network interface 216, other hardware 226, data store 218, and input/output interface. As shown in the figure, each of the components of the computing device 210 may be interconnected using a system bus 232 in a communicating relationship for sharing controls, commands, data, power, and so forth.

Methods and systems described herein can be realized using the processor 212 of the computer system 200 to execute one or more sequences of instructions contained in the memory 214 to perform predetermined tasks. In embodiments, the computing device 200 may be deployed as a number of parallel processors synchronized to execute code together for improved performance, or the computing device 200 may be realized in a virtualized environment where software on a hypervisor or other virtualization management facility emulates components of the computing device 200 as appropriate to reproduce some or all of the functions of a hardware instantiation of the computing device 200.

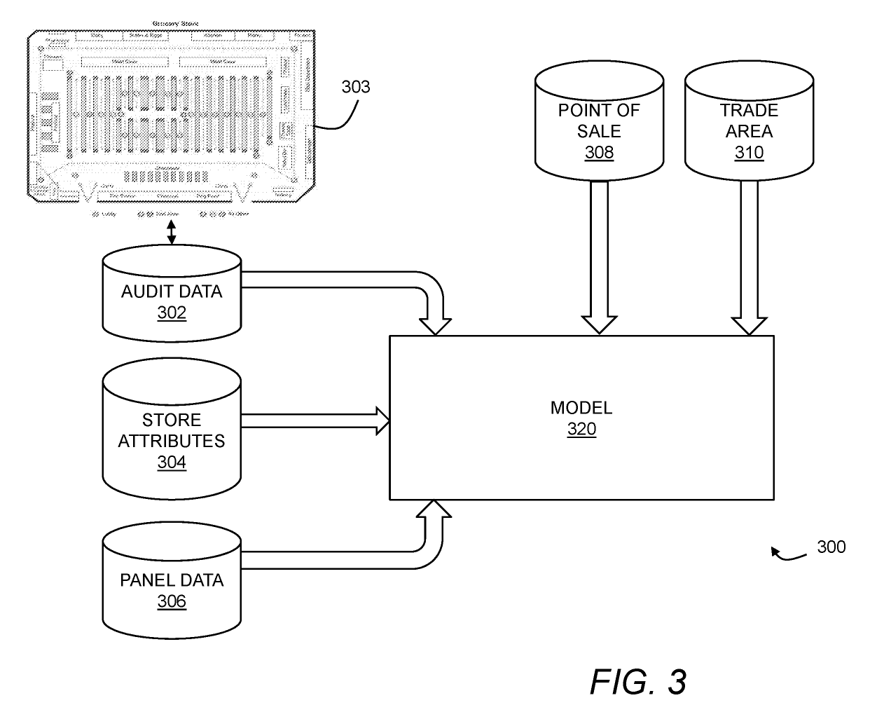

FIG. 3 illustrates a data environment for a modeling process. In general, data sources in the data environment 300 may include audit data 302, store attributes 304, panel data 306, point of sale data 308, and trade area data 310, all of which may be synthesized as described herein to create a model 320 relating information about actual store displays to trip outcomes for shoppers.

In general, audit data 302 may include information describing displays within a number of stores. Audit data 302 may be acquired from in-person inspections of individual stores, such as through routine visits and examination by audit personnel who travel to stores and record information relating to display contents, location, size, product mix and so forth. The audit data 302 may include information about a number of different stores, with the data for each store characterizing a number of retail displays according to various display attributes such as a display type and a location within the store. The information may be provided at any degree of granularity. For example, a display attribute for location may specify proximity to a store section (e.g., produce, pharmacy, lobby, etc.), details of the display location such as that a display is an end cap (e.g., a display at the end of an aisle—a prominent and highly coveted location in retail venues) or that a display is at a store entrance (indoor or outdoor), and so forth. Location may also or instead be specified with reference to a store map 303 or other mechanism for more precise attribution of location to a particular display. A display attribute for content may specify a particular item or product mix that is displayed, or a brand that is displayed (independent of specific products), a sponsor or celebrity within the display, and so forth. A display attribute for physical characteristics may specify height, size, product volume, quantity of product and so forth. More generally, the display attributes captured within the audit data 302 may include any features or aspects of a display that might be useful for measuring merchandising conditions or display effectiveness including potentially related information such as number of displays in a store, competitor display information, and so forth.

Audit data 302 may be manually captured by an audit team on some regular basis such as once a day, once a week, once every two weeks, or on any other fixed or variable schedule suitable for accurately reflecting the pace of change in product displays or ensuring that displays are maintained in a desired or expected condition. Where a store chain internally captures sufficiently detailed display information on a store-by-store basis, the audit data may be obtained directly from the store chain without requiring manual, in-person visits.

Store attributes 304 may include any of a variety of objective attributes of stores within a trade area. This may, for example, include a type or category for each store, such as clothing, grocery, pharmacy, warehouse, restaurant, convenience, fast food, or any other type or combination of types. The store attributes 304 may also include a size, which may be measured in square footage or with reference to a size category or other metric. Store attributes 304 may also include economic data such as annual sales, total product volume, and so forth. In general, the store attributes 304 may be associated with specific, known retail venues within a trade area, which may be uniquely identified by a store number, street address, or any other identifier for uniquely identifying a retail location. In general, store attributes 304 will be reported by the stores themselves, however this information may also be acquired in other ways such as from third party data suppliers or manual inspection and collection of relevant data. The store attributes 304 may be combined with audit data 302, which is also acquired on a store-by-store basis so that store attributes 304 can be easily and accurately correlated with audit data 302.

Panel data 306 may include any data gathered from a panel of consumers about shopping activity. In addition to specific purchase data, panel data 306 may include (for each panel member) shopping behavior, shopping history, trip types, demographics, residence or other geographic information such as shopping locations, and so forth. A panel member may be an entire household or an individual within a household, with suitable adaptations being made to data gathering and recording. Panel data 306 may also or instead include summary data based on shopping history including current and historical trips. Thus data for each panel member may be characterized in part based on backward-looking shopping trips for, e.g., a prior twelve month period or any other suitable window. Other summary data may be prepared, such as an amount of a particular product purchased over some prior window and a categorization of the panel member by shopper type (e.g., a heavy buyer, a light buyer, a non-buyer, etc.). While demographic data such as age, income, and gender may be fairly stable for each panel member, shopping behavior may change significantly over time, thus forming a highly dynamic aspect of a consumer panel and individual panel members therein.

Panel data 306 may be gathered using a variety of techniques, and generally contains very detailed and accurate shopping data for particular consumers (e.g., a household or an individual) in a panel who record their shopping activity and report this shopping activity over regular intervals. For example, panel data 306 may be gathered from volunteer consumer panels that provide detailed shopping reports by entering a store name and then scanning a basket of goods purchased from that store upon return from each shopping trip using a bar code scanner or the like. While this form of data capture usefully provides a source identifier, conventional panel data may not uniquely identify a particular store for each purchase. Instead, a panel member may only enter a store name, which can prevent matching of consumer purchases in the panel data 306 to particular display configurations at particular stores in the audit data 302. Alternatively, a panel provider can collect the specific store location, which can facilitate the shopper to audit store matching.

In cases where the specific store location is not captured, panel data 306 and audit data 302 may only be loosely associated. The techniques disclosed herein may advantageously apply other insights concerning shopper behavior to build a bridge between these disparate data sets sufficient for accurate statistical modeling. In particular, through independent investigation using survey data, it has been discovered that a substantial portion of purchases (e.g., greater than eighty percent) associated with a store by name are actually made at the physical store location for that name that is geographically closest to a corresponding panel member's residential address. In a simplified modeling process, this correlation may be applied to form a direct link between the store name and the closest instance of that store to a particular panel member, which provides sufficiently accurate modeling for useful predictions of response to displays as contemplated herein. However, more complex modeling of this relationship may also or instead be employed, for example to account for vacation travel to distant geographic locations, tendencies based on commuter travel, or combinations of these that account for multi-member households and so forth. In another aspect, GPS information or other location information for particular shoppers may be used to improve accuracy where this information is available and can be correlated to particular purchases.

Point of sale data 308 includes aggregate shopping data for particular retail locations, which may be provided by a store to facilitate internal data analysis, or sold by the store to third parties (in anonymized form, as appropriate) for use in marketing analytics and the like. In general, point of sale data 308 describes aggregated single store sales for various products based on purchases recorded at the store over some relevant time period (e.g., daily, weekly, monthly, quarterly, annually, etc.). In addition to item-by-item information, this may include basket data describing what items are purchased together, and more detailed or granular data may be available for products and/or time periods in certain instances. This data may also or instead be disposed in separate ‘basket data’ or transition log (flog′) data, i.e., instead of point of sale data 308.

Trade area data 310 may include demographic information for an area of interest. Trade area data 310 is widely available from a variety of commercial providers in various formats and at various levels of detail.

The various data sources described above may be combined into a model 320 that predicts shopping behavior based on merchandise displays and changes thereto. In general, the data sources are combined and analyzed to derive a regression model that identifies shopper characteristics responsive to a display, or otherwise associates trip outcomes with display attributes. A variety of statistical and other modeling techniques may be usefully applied to derive this model 320, as discussed in greater detail below. In one significant respect, the modeling process uses geographic inferences to link panel data 306 to audit data 302 for particular stores so that the actual response of panel members to particular display attributes can be captured and use to develop predictive models. More generally, information about activity by particular shoppers (panel data), when combined with current in-store promotions and displays (audit data), can be used to model whether a particular shopper, trip type and/or the basket contents are influenced by a particular in-store display to purchase the item(s) that are on the display. These inferences can further be projected onto a larger population or trade area using other trade area data 310 to predict impact within a trade area of different promotional strategies that use in-store displays.

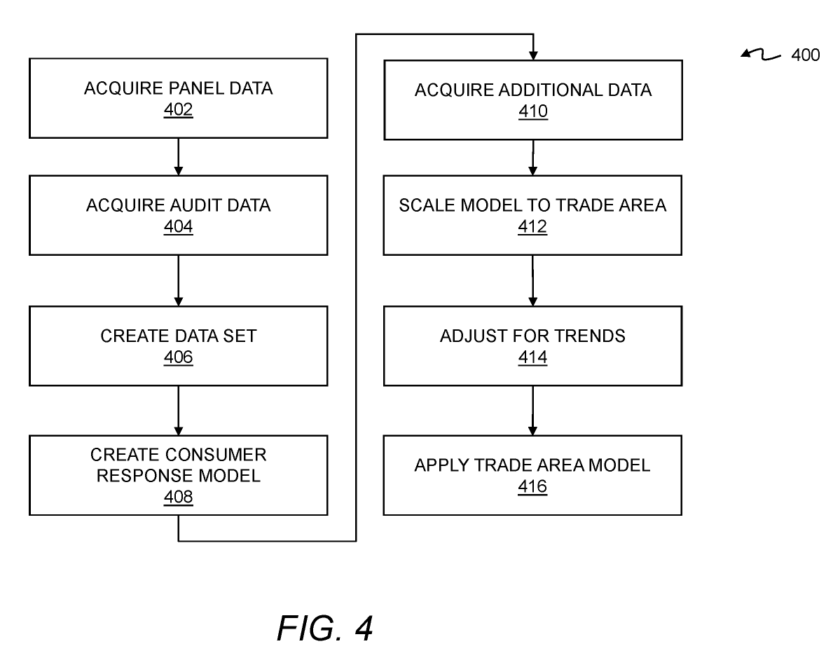

FIG. 4 shows a method for evaluating impact of in-store displays.

As shown in step 402, the method 400 may include acquiring panel data such as any of the panel data described above. In general, the panel data may include a number of purchase records reported by a number of consumers in a panel for a number of shopping trips. Each purchase record for one of the shopping trips may identify a store name for a store without providing a specific location of the store. While this may provide a great convenience to a consumer who volunteers to participate in a panel, it also creates a gap in reporting data because the consumer's purchasing behavior cannot be accurately correlated to a specific shopping location where display information would otherwise be available in store audit data as described above. The panel data may include other relevant information about shopping behavior, such as a time of the shopping trip, products purchased and a number and of items purchased for each product. The panel data may also include a plurality of consumer demographic attributes for each panel member, which may be provided for example, when the panel member joins the panel or at some other convenient time. Demographic attributes may be any conventional demographic attributes such as age, income, gender, and the like, or any other attributes useful for categorizing individuals or populations into types of shoppers. These attributes may also or instead include residence information or other geographical data such as shopping areas and the like.

In this context, it should be appreciated that acquiring panel data (and more generally, acquiring any data in the methods contemplated herein) may refer to two separate acquisition steps. A first acquisition step includes the acquisition of the data from primary data sources such as bar code scanners or other record keeping devices used by panel members to report purchasing history. Similarly, for audit data this may include display attribute data gathered on a laptop, smart phone or other device by a store auditor. This data may be acquired and aggregated into a database for subsequent use. A second, alternative acquisition step includes retrieval of this aggregated data from a database or other data resource for use in the modeling and other data processing steps described herein. Thus the overall process described herein includes acquisition of initial data from consumers or any other primary source, as well as acquisition of data from a database or other data resource for use in statistical modeling and other computer processing. Where the primary data acquisition is specifically contemplated, the step will be referred to as “acquiring data from a primary data source.” Where the database or other resource is specifically contemplated, the step will be referred to as “acquiring data from a computerized data resource.” More generally, both meanings are intended, unless a more specific meaning is explicitly provided or otherwise clear from the context.

As shown in step 404, the method 400 may include acquiring audit data, such as any of the audit data described above. The audit data may generally include display data from a number of retail locations that characterizes a number of retail displays within the number of retail locations according to one or more display attributes such as store location, display content, display size, and so forth. Each item of audit data may also specify an audit time at which the item of audit data was acquired from a corresponding one of the retail locations.

As shown in step 406, the method 400 may include creating a data set that synthesizes the audit data and the panel data. In particular, the data set may be created by associating each store name in one of the purchase records of the panel data with one of the number of retail locations of the audit data having a corresponding store name that is geographically nearest to the consumer that provided the one of the purchase records.

As shown in step 408, the method 400 may include creating a consumer response model that can be used to predict trip outcomes based on in-store display attributes. In general, the consumer response model estimates the relationship of display attributes to specific shopping outcomes. More specifically, this may include relating the one or more display attributes (used as one or more independent variables in a statistical model) to a dependent variable that is based on a trip outcome. For example, the consumer response model may include a mixed effect regression model or any other statistical model or the like that estimates how one of a number of shopper types responds incrementally to a change in one of the display attributes.

The one or more display attributes may be, for example, any of the display attributes described above. It will be appreciated that other independent variables may also or instead be employed. For example, the independent variables may include a shopper type indicative of a propensity for a particular purchasing behavior. For each panel member, this propensity may be represented as a quantitative metric (e.g., a numerical value characterizing a propensity for a particular type of purchase). This may also or instead be represented as a category such as ‘light buyer’, ‘heavy buyer’, etc. Thus the independent variables may include a shopper type specifying a category of purchasing behavior with respect to one or more products. Another useful independent variable may be other items purchased during a store visit. The independent variables may also or instead include an attribute from the store data, such as a store type, a store size (e.g., square footage), a location, or an amount of sales.

A trip mission may also or instead be used as an independent variable. In general, a trip mission categorizes a shopping trip by an overall mission of the consumer. For example, a weekly shopping trip may be one kind of trip mission with certain shopping and purchasing characteristics. A morning coffee run may be a different trip mission, as may a fuel stop at a convenience store. Each trip mission may have its own characteristic shopper behavior, and thus identifying a trip mission provides a useful base for measuring various effects of a particular display attribute. Thus where a particular trip mission can be identified, that trip mission can provide a highly useful independent variable.

The trip outcome—the result of interest—may also be represented in a number of manners. The trip outcome objectively represents a result of shopping trip (product x was purchased), and provides a basis for evaluating the effectiveness of various display attributes. For example, the trip outcome may include a purchase of a predetermined good such as a consumer packaged good, or the purchase of a particular basket of goods or the like. As described above, a set of trip outcomes may be linked to specific stores based on where panel members live. More specifically, the trip outcomes may linked to geographic locations of the retail venues for each one of the set of trip outcomes based on a geographic relationship between a home location of a corresponding one of the predetermined group of consumers and a number of geographic locations of a corresponding number of stores for the retail venue. In a simplified model, the geographic relationship may be the nearest one of the named stores, however, other techniques may be used where more specific information is available for a particular shopping trip.

As shown in step 410, the method 400 may include acquiring additional data. While panel data and audit data may permit the creation of a model that relates display attributes to trip outcomes, it may be useful to scale this model to make predictions that span a larger or different trade area, or that are used to adjust the consumer predictions for external influences such as trade area, store type, and the like. In order to scale the model accurately, the additional data may, for example include trade area data including various data types from various data sources for a trade area of interest. For example, trade area data may include retail store data, demographic data, and point of sale data as generally described above. For example, the trade area data may include demographic data characterizing a population within a trade area of interest according to one or more trade area demographic attributes. Retail store data may include a square footage, a location, and an amount of sales for each of the number of retail locations. The point of sale data may describe an amount of a product sold over a predetermined time period for each of the retail locations. More generally, the additional data may include any data necessary or helpful for accurately scaling a consumer response model to a different or larger trade area. The additional data may also or instead be used for one or more of the creation, refinement, or scaling of the consumer response model.

As shown in step 412, the method 400 may include refining the consumer response model and scaling the consumer response model to the trade area. This may generally be based on a relationship between the trade area data and the plurality of consumer demographic attributes for the number of consumers in the panel, however other adjustments and statistical techniques may also or instead be employed. In general the scaling may yield a trade area consumer response model—the consumer response model scaled to the trade are of interest—that includes the independent and dependent variables of the original consumer response model.

As shown in step 414, the method 400 may include adjusting the consumer response model according to at least one trend in consumer behavior, such as a trend identified in the point of sale data. For example, the trend may include a seasonal trend in purchasing behavior such as increased purchasing of ice or lemonade in summer months, or increased purchasing of hot chocolate or windshield wiper fluid in winter. These trends may be used to adjust a model so that monthly, annual, or holiday seasonal trends (or any other trend) are accounted for when applying the model. Other trends may include long or short term trends in consumer behavior that are not periodic or correlated to particular seasons.

As shown in step 416, the method 400 may include applying the trade area consumer response model to estimate consumer responses within the trade area to display attributes or changes thereto. For example, this may include applying the trade area consumer response model to estimate the trip outcome for the trade area based on the one or more display attributes. Applying the model may also or instead include estimating a change in the trip outcome based on a change in the one or more display attributes, such as where a display is increased in size or moved to a different location in a store. Applying the model may also or instead include estimating a change in the trip outcome based any other independent variables, e.g., for comparison to display changes or in addition to the display changes.

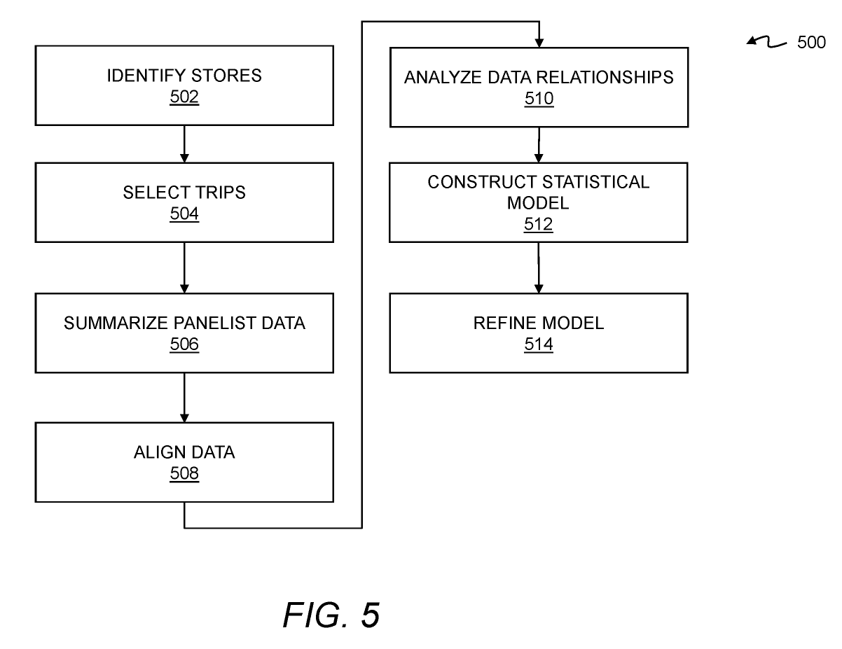

FIG. 5 illustrates a method for developing a consumer response model. A wide range of statistical and other modeling techniques are known in the art, and may be usefully employed to relate display attributes to trip outcomes as contemplated herein. The following description outlines one useful technique for reliably creating a mixed effect regression model that captures this relationship.

As shown in step 502, the process 500 may begin with identifying stores where panelists shop. By using survey data, the applicant has determined that a substantial number of purchases are at the store under a banner (the global, corporate name for a particular store, e.g., Walmart or Kroger) that is closest to the panelist's home. However, this assumption may vary for particular regions, or over time, and this assumption should be verified, or modified as appropriate, before using this to link store-agnostic panel data to store-specific display data. Other data such as GPS data may be used instead of or in addition to survey data to aid in identifying specific stores visited by panelists.

As shown in step 504, the process 500 may include selecting relevant trips from panel data. In order to facilitate a trip-level analysis of data, the panel data may be filtered to focus on trips that occurred specifically at audit stores. This determination may, where necessary, be based on the assumptions or other information described above for linking trips to specific audit stores where display attribute data is available.

As shown in step 506, panelist data may be summarized, such as current and historical trip information, and panelist behavior for all trips. This may include audit stores, and every other store, all of which may provide useful historical context for panelists independent of the trips to audit stores. For example, this may include a current, specific trip to an audit store, as well as historical, backward looking information for all trips associated with the panelist over some historical window such as six or twelve months, or any other period for which information is available and potentially relevant to current shopping behavior. Summary data may, for example, include specific data such as how much of a product a panelist purchased over the historical window, or the type of shopper that the panelist is with respect to the product (e.g., heavy buyer, light buyer, cost-sensitive buyer, and so forth). There are many ways to usefully summarize panelist behavior into categories, any of which may be used in the summary data contemplated in this step. This data may be re-summarized periodically in order to ensure that modeling reflects current panelist behavior.

As shown in step 508, the process 500 may include aligning data. In general, this step seeks to align various, disparate data sets into a common form for use together in modeling. This may, for example, include aligning the panel transaction data selected in step 504, the panelist characteristics identified in step 506, point of sale data from retailers, audit data for display attributes in specific stores, demographic attributes for panelists, and any other data. By aligning the data set to data for specific audit store trips, analysis can be performed at a trip level. Data can also be adjusted for seasonality for any product categories of interest using point of sale data. This alignment step may result in a modeling data set that can be used for subsequent statistical analysis. For example, the modeling data set may include a row for each trip to an audit store, and columns for any other information specific to the store, displays, panelist, and so forth.

The resulting data set may, for example, include a comprehensive store-shopper-trip level database that includes various items of data in each record. For example, the data set may include basket level information such as contents within a basket, the size of the basket, the trip mission, and so forth. The data set may also or instead include shopper level information such as a shopper purchase history from the prior six to twelve months across all outlets, shopper demographics, shopper segmentation criteria (e.g., shopper type), and so forth. The data set may also or instead include display attributes such as the number of displays, location of displays, and any other display attributes described herein. The data set may also or instead include store trade area attributes such as median income, average age, and other demographic attributes for a trade area that includes the store for a trip. The data set may also or instead include store level information such as number of aisles, square footage, annual sales, and any other store attributes described herein. The data set may also or instead include trend data for stores derived from point of sale data such as seasonal trend data and any other trend data for product categories of interest.

As shown in step 510, the process 500 may include analyzing data relationships for the modeling data set. This may, for example, include specific investigation of the relationship between trip conversions or other trip outcomes and the display attributes acquired for store audits. Analysis may begin, for example, by selecting a relevant dependent variable such as purchase of a specific product, purchase of a group of products, or any other trip outcome of interest. Relationships among all of the other data may then be investigated to identify negative or positive correlations that identify the main effects influencing conversion and buy rate for a product of interest, independent of display attributes. More generally, suitable techniques are well known in the art, including general techniques for exploratory data analysis (see, e.g., Exploratory Data Analysis by John W. Tukey (1977), the entire content of which is hereby incorporated by reference), any of which may be used to identify relevant relationships among data for use in building a consumer response model.

As shown in step 512, the process 500 may include constructing a statistical model for estimating consumer response to changes in display attributes. This may, for example, include creating a statistical model relating display attributes to trip conversion as generally contemplated herein, however any other independent variables may be used instead of or in addition to display attributes for creating useful statistical models of consumer behavior and response. The modeling may include the calculation of coefficients for a linear regression model, or any other technique or combination of techniques for creating a model that relates display attributes to trip outcomes. This may also include scaling the statistical model to a different or larger trade area than the trade area for the consumer panel. A variety of techniques are known for scaling a statistical model in this manner, any of which may be adapted

As shown in step 514, the process 500 may include refining the model. This may include identifying interaction effects. In general, two independent variables interact in a statistical sense of the effect of one of the independent variables differs depending on a level of the other. With display attributes and other independent variables (esp. other causals such as price or product features), there may be numerous interaction effects that can influence purchasing behavior and response to changes in display attributes in expected ways. By identifying these interaction effects, the model can be adapted to more closely reflect actual shopping behavior. For example, certain behavior may be responsive to both a particular display attribute and a particular store characteristic. By capturing and accounting for this interaction effect, consumer response can be more accurately modeled according to the relevant independent variables.

For example, consumer response might be evaluated according to who the consumer is, e.g., the specific panel member, but the response might also or instead be evaluated according to the trip mission. That is, a consumer visiting a store for a single item might respond differently to a display than a consumer visiting the store on a weekly shopping trip. So the trip mission may provide one useful independent variable that can be incorporated into the model. In general, a trip mission may be any descriptive category that can be used to differentiate among different types of shopping trips by panelists. In general, the trip mission or “trip segment” is defined by the specific items that are purchased, but other characteristics may also or instead be used to categories a shopping trip based on, e.g., location, time of day, amount spent, and so forth. The trip mission may be used as an independent variable, and may have strong interaction effects in a mixed effect regression model.

In order to address these types of mixed effects, a number of interaction terms may be created to test and determine, e.g., which shopper, trip or basket attributes exhibit significantly higher or lower conversion rates or buy rates, and these interaction terms may be incorporated into the model used to determine responsiveness to an in-store display.

In another aspect, the model may be refined by manually adding or dropping independent variables, adjusting coefficients, or otherwise tweaking, weighting, or adjusting the model according to objective or subjective criteria. More generally, any statistical or other modeling techniques may be used to investigate, test, refine, or otherwise modify the model according to intended use or desired results. In another aspect, the model may be used without further refinements after the original mixed effects regression model is created. Once the model is in a suitable state for use, the model may be used as desired to evaluate the impact of in-store displays on shopper behavior as generally contemplated herein.

In general, the methods described above may be realized as a computer program product embodied in a non-transitory computer readable medium that, when executing on a computer, performs some or all of the steps described above. In another aspect, a computer may be configured to perform the steps described herein. In this latter case, there is disclosed herein a system comprising a memory storing panel data characterizing purchasing behavior of a predetermined group of consumers in a panel, audit data characterizing product displays at a number of retail location, wherein the purchasing behavior identifies retail venues by store name but not by geographic location, trade area data and demographic attributes for the predetermined group of consumers in the panel. The system may further include a processor configured to create a consumer response model by relating one or more independent variables including the one or more display attributes to a dependent variable based on a trip outcome, wherein a set of trip outcomes is linked to geographic locations of the retail venues for each one of the set of trip outcomes based on a geographic relationship between a home location of a corresponding one of the predetermined group of consumers and a number of geographic locations of a corresponding number of stores for the retail venue, the processor further configured to scale the consumer response model to a trade area based on a relationship between the trade area data and demographic attributes for the predetermined group of consumers in the panel, thereby providing a trade area consumer response model including the one or more independent variables and the dependent variable. The system may further include a physical display device coupled to the processor and configured by the processor to present a user interface for applying the consumer response model to estimate the trip outcome for the trade area based on the one or more display attributes.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, R, SAS, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it may be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A method comprising:
acquiring panel data, the panel data including a number of purchase records reported by a number of consumers in a panel for a number of shopping trips, each purchase record for one of the shopping trips identifying a store name for a store without providing a specific location of the store, a time of the one of the shopping trips, and a number of items purchased at the store during the one of the shopping trips, and each one of the number of consumers having a plurality of consumer demographic attributes;
acquiring audit data from a number of retail locations, the audit data characterizing a number of retail displays within the retail locations according to one or more display attributes, each item of audit data further specifying an audit time at which the item of audit data was acquired;
creating a data set by associating each store name in one of the purchase records of the panel data with one of the number of retail locations of the audit data having a corresponding store name that is geographically nearest to the consumer that provided the one of the purchase records;
creating a consumer response model by relating one or more independent variables including the one or more display attributes to a dependent variable based on a trip outcome;
acquiring trade area data including retail store data for the number of retail locations, point of sale data for the number of retail locations, and demographic data for a geographic area containing the number of retail locations, wherein the retail store data includes a square footage, a location, and an amount of sales for each of the number of retail locations, the point of sale data describes an amount of a product sold over a predetermined time period for each of the retail locations, and the demographic data characterizes a population within the trade area according to one or more trade area demographic attributes;
refining the consumer response model and scaling the consumer response model to the trade area based on a relationship between the trade area data and the plurality of consumer demographic attributes for the number of consumers in the panel, thereby providing a trade area consumer response model including the one or more independent variables and the dependent variable; and
applying the trade area consumer response model to estimate the trip outcome for the trade area based on the one or more display attributes.

2. The method of claim 1 wherein the plurality of demographic attributes includes at least one of age and income.

3. The method of claim 1 wherein the trip outcome includes a purchase of a predetermined good.

4. The method of claim 1 wherein the trip outcome includes a purchase of a consumer packaged good.

5. The method of claim 1 further comprising estimating a change in the trip outcome based on a change in the one or more display attributes.

6. The method of claim 1 further comprising estimating a change in the trip outcome based on a change in one or more other independent variables.

7. The method of claim 1 wherein the one or more independent variables include a shopper type indicative of a propensity for a particular purchasing behavior.

8. The method of claim 1 wherein the one or more independent variables include a shopper type specifying a category of purchasing behavior with respect to one or more products.

9. The method of claim 1 wherein the one or more independent variables include one or more other items purchased during a store visit.

10. The method of claim 1 wherein the one or more independent variables include a trip mission.

11. The method of claim 1 wherein the one or more independent variables include at least one attribute from the retail store data.

12. The method of claim 11 wherein the at least one attribute includes an attribute selected from a group consisting of a square footage, a location, or an amount of sales.

13. The method of claim 1 wherein the display attributes include one or more of a size of one of the displays, an item in one of the displays, and a quantity of products in one of the displays.

14. The method of claim 1 wherein the display attributes include a location of one of the displays, wherein the location is selected from a group consisting of an end cap, a store entrance, and a proximity to a store section.

15. The method of claim 1 wherein the consumer response model includes a mixed effect regression model that estimates how one of a number of shopper types responds incrementally to a change in one of the display attributes.

16. The method of claim 1 further comprising adjusting the consumer response model according to at least one trend in consumer behavior identified in the point of sale data.

17. The method of claim 16 wherein the at least one trend includes a seasonal trend.

18. A computer program product comprising computer executable code embodied in a non-transitory computer readable medium that, when executing on one or more computing devices, performs the steps of:
acquiring panel data, the panel data including a number of purchase records reported by a number of consumers in a panel for a number of shopping trips, each purchase record for one of the shopping trips identifying a store name for a store without providing a specific location of the store, a time of the one of the shopping trips, and a number of items purchased at the store during the one of the shopping trips, and each one of the number of consumers having a plurality of consumer demographic attributes;
acquiring audit data from a number of retail locations, the audit data characterizing a number of retail displays within the retail locations according to one or more display attributes, each item of audit data further specifying an audit time at which the item of audit data was acquired;
creating a data set by associating each store name in one of the purchase records of the panel data with one of the number of retail locations of the audit data having a corresponding store name that is geographically nearest to the consumer that provided the one of the purchase records;
creating a consumer response model by relating one or more independent variables including the one or more display attributes to a dependent variable based on a trip outcome;
acquiring trade area data including retail store data for the number of retail locations, point of sale data for the number of retail locations, and demographic data for a geographic area containing the number of retail locations, wherein the retail store data includes a square footage, a location, and an amount of sales for each of the number of retail locations, the point of sale data describes an amount of a product sold over a predetermined time period for each of the retail locations, and the demographic data characterizes a population within the trade area according to one or more trade area demographic attributes;
refining the consumer response model and scaling the consumer response model to the trade area based on a relationship between the trade area data and the plurality of consumer demographic attributes for the number of consumers in the panel, thereby providing a trade area consumer response model including the one or more independent variables and the dependent variable; and
applying the trade area consumer response model to estimate the trip outcome for the trade area based on the one or more display attributes.

19. A method comprising:
acquiring panel data characterizing purchasing behavior of a predetermined group of consumers in a panel and audit data characterizing product displays at a number of retail location, wherein the purchasing behavior identifies retail venues by store name but not by geographic location;
creating a consumer response model by relating one or more independent variables including the one or more display attributes to a dependent variable based on a trip outcome, wherein a set of trip outcomes is linked to geographic locations of the retail venues for each one of the set of trip outcomes based on a geographic relationship between a home location of a corresponding one of the predetermined group of consumers and a number of geographic locations of a corresponding number of stores for the retail venue;
refining the consumer response model and scaling the consumer response model to a trade area based on a relationship between the trade area data and demographic attributes for the predetermined group of consumers in the panel, thereby providing a trade area consumer response model including the one or more independent variables and the dependent variable; and
applying the trade area consumer response model to estimate the trip outcome for the trade area based on the one or more display attributes.

20. A system comprising:
a memory storing panel data characterizing purchasing behavior of a predetermined group of consumers in a panel, audit data characterizing product displays at a number of retail location, wherein the purchasing behavior identifies retail venues by store name but not by geographic location, trade area data and demographic attributes for the predetermined group of consumers in the panel;
a processor configured to create a consumer response model by relating one or more independent variables including the one or more display attributes to a dependent variable based on a trip outcome, wherein a set of trip outcomes is linked to geographic locations of the retail venues for each one of the set of trip outcomes based on a geographic relationship between a home location of a corresponding one of the predetermined group of consumers and a number of geographic locations of a corresponding number of stores for the retail venue, the processor further configured to refine and scale the consumer response model to a trade area based on a relationship between the trade area data and demographic attributes for the predetermined group of consumers in the panel, thereby providing a trade area consumer response model including the one or more independent variables and the dependent variable; and
a physical display device coupled to the processor and configured by the processor to present a user interface for applying the trade area consumer response model to estimate the trip outcome for the trade area based on the one or more display attributes.
